(19) United States
(12) Patent Application Publication
(10) Pub. No.: US 2024/0306264 A1
(43) Pub. Date: Sep. 12, 2024

(54) Plate Shaped Heater, Heating Unit and Heat Shrink Machine

(71) Applicant: Tyco Electronics (Shanghai) Co., Ltd., Shanghai (CN)

(72) Inventors: Zhen Wang, Shanghai (CN); Yiqun (Cham) Zhu, Shanghai (CN); Zheng Gu, Shanghai (CN)

(73) Assignee: Tyco Electronics (Shanghai) Co., Ltd., Shanghai (CN)

(21) Appl. No.: 18/596,795

(22) Filed: Mar. 6, 2024

(30) Foreign Application Priority Data
Mar. 7, 2023 (CN) 202310213145.9

(51) Int. Cl. H05B 3/06; H05B 3/22

(52) U.S. Cl. CPC H05B 3/06; H05B 3/22

(57) ABSTRACT

A plate shaped heater for heating a heat shrink tube on a cable includes a housing, multiple heating tubes arranged within the housing, and a heating wire arranged in the multiple heating tubes. The housing defines opposite ends in its longitudinal direction. The heating tubes extend along a transverse direction of the housing and are arranged in a row along the longitudinal direction of the housing. An arrangement density of the heating tubes in two end regions proximate two ends of the housing is greater than an arrangement density of the heating tubes in a middle region between the two end regions of the housing.

### CROSS-REFERENCE TO RELATED APPLICATION

This application claims the benefit of Chinese Patent Application No. CN202310213145.9 filed on Mar. 7, 2023, in the State Intellectual Property Office of China, the whole disclosure of which is incorporated herein by reference.

### FIELD OF THE INVENTION

The present invention relates to a plate shaped heater, a heating unit including the plate shaped heater, and a heat shrink machine including the heating unit.

BACKGROUND

A heating unit of a heat shrink machine usually includes two plate shaped heaters, for example, an upper heater and a lower heater. In the prior art, these arrangements are only capable of producing heating region with uniform temperature in a middle area or section of the heating unit. As a result, its two ends are unable to be used for heating the wire harness heat shrink tube. This not only reduces production efficiency but also wastes energy. In addition, in the prior art, due to structural limitations, the density of the heating wire at both ends of the heater cannot be increased, which results in the temperature at both ends of the heating unit being lower than the middle temperature. Thus, the two ends cannot be used for heating the wire harness heat shrink tube, affecting the improvement of production efficiency.

In the prior art, the normal operating temperature of the heater of the heat shrink machine is between 500-600° C. The temperature difference with the external environment is therefore large. During heating, heat will be lost through the openings at both ends of the upper and lower heaters. This results in lower temperatures at the two ends of the heater, which also leads to uneven heating.

### SUMMARY

A plate shaped heater for heating a heat shrink tube on a cable includes a housing, multiple heating tubes arranged within the housing, and a heating wire arranged in the heating tubes. The housing defines opposite ends in its longitudinal direction. The heating tubes extend along a transverse direction of the housing and are arranged in a row along the longitudinal direction. An arrangement density of the heating tubes in two end regions proximate two ends of the housing is greater than an arrangement density of the heating tubes in a middle region between the two end regions of the housing.

### BRIEF DESCRIPTION OF THE DRAWINGS

The invention will now be described by way of example with reference to the accompanying Figures, of which:

FIG. 1 shows an illustrative perspective view of a heat shrink machine according to an exemplary embodiment of the present invention;

FIG. 2 shows an illustrative perspective view of a body of a heat shrink machine according to an exemplary embodiment of the present invention;

FIG. 3 shows an illustrative perspective view of a heat shrink machine according to an exemplary embodiment of the present invention, wherein the first upper safety cover on the first support platform is opened, and the second upper safety cover on the second support platform is closed;

FIG. 4 shows an illustrative perspective view of a heating device of a heat shrink machine according to an exemplary embodiment of the present invention;

FIG. 5 shows an illustrative perspective view of a motion mechanism of a heat shrink machine according to an exemplary embodiment of the present invention when viewed from one side;

FIG. 6 shows an illustrative perspective view of a motion mechanism of a heat shrink machine according to an exemplary embodiment of the present invention when viewed from the other side;

FIG. 7 shows an illustrative perspective view of a slot rail of a motion mechanism according to an exemplary embodiment of the present invention;

FIG. 8 shows an illustrative perspective view of a heating device of a heat shrink machine according to an exemplary embodiment of the present invention when viewed from one side;

FIG. 9 shows an illustrative perspective view of a heating device of a heat shrink machine according to an exemplary embodiment of the present invention when viewed from the other side;

FIG. 10 shows an illustrative perspective view of a heating device of a heat shrink machine according to an exemplary embodiment of the present invention, wherein the first crossbeam 310 is removed;

FIG. 11 shows an illustrative view of a heat shrink machine according to an exemplary embodiment of the present invention, wherein the heating device is located on a first support platform;

FIG. 12 shows an illustrative view of a heating device of a heat shrink machine according to an exemplary embodiment of the present invention, wherein the heating device is located at the first heating station and in the first heating orientation;

FIG. 13 shows an illustrative view of a heating device of a heat shrink machine according to an exemplary embodiment of the present invention, wherein the heating device is located at a second heating station and in a second heating orientation;

FIG. 14 shows a sectional view of a heat shrink machine according to an exemplary embodiment of the present invention, wherein the heating unit is located at the heating station;

FIG. 15 shows a partially enlarged schematic diagram of the heat shrink machine shown in FIG. 14, which shows the heating unit, heat reflection plate, and safety cover;

FIG. 16 shows an illustrative perspective view of a heating unit of a heat shrink machine according to an exemplary embodiment of the present invention;

FIG. 17 shows an illustrative perspective view of a plate shaped heater according to an exemplary embodiment of the present invention;

FIG. 18 shows a longitudinal sectional view of a plate shaped heater according to an exemplary embodiment of the present invention;

FIG. 19 shows a vertical cross-sectional view of a plate shaped heater according to an exemplary embodiment of the present invention;

FIG. 20 shows a cross-sectional view along the horizontal direction of a plate shaped heater according to an exemplary embodiment of the present invention; and

FIG. 21 shows a schematic arrangement diagram of a heating unit and a heat reflection plate according to an exemplary embodiment of the present invention.

The features disclosed in this disclosure will become more apparent in the following detailed description in conjunction with the accompanying drawings, where similar reference numerals always identify the corresponding components. In the accompanying drawings, similar reference numerals typically represent identical, functionally similar, and/or structurally similar components. Unless otherwise stated, the drawings provided throughout the entire disclosure should not be construed as drawings drawn to scale.

### DETAILED DESCRIPTION OF THE EMBODIMENTS

Exemplary embodiments of the present disclosure will be described hereinafter in detail with reference to the attached drawings, wherein the like reference numerals refer to the like elements. The present disclosure may, however, be embodied in many different forms and should not be construed as being limited to the embodiment set forth herein; rather, these embodiments are provided so that the present disclosure will be thorough and complete, and will fully convey the concept of the disclosure to those skilled in the art.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

Embodiments of the present disclosure include a plate shaped heater for heating a heat shrink tube on a cable. The plate shaped heater includes a housing with opposite ends in its longitudinal direction, multiple heating tubes provided in the housing, and a heating wire provided in the multiple heating tubes. The heating tube extends along a transverse direction of the housing. The multiple heating tubes are arranged in a row along the longitudinal direction of the housing. The arrangement density of the heating tubes in two end regions near two ends of the housing is greater than the arrangement density of the heating tubes in a middle region between the two end regions of the housing.

According to another embodiment of the present disclosure, a heating unit includes a base plate, and a pair of plate shaped heaters having ends connected to the base plate. The pair of plate shaped heaters are spaced opposite and parallel to each other in a height direction, perpendicular to a longitudinal direction and a transverse direction of the plate shaped heater. The heaters are adapted to heat the heat shrink tubes on cables located therebetween.

A heat shrink machine according to another embodiment of the present disclosure includes a body having a containment chamber located at a standby station and a support platform located at a heating station. Cable clamps are installed on the support platform for clamping cables with heat shrink tubes. The machine further includes the above heating unit for heating the heat shrink tubes on the cables, and a motion mechanism. The motion mechanism is connected to the base plate of the heating unit and is adapted to drive the heating unit to move between the standby station and the heating station, and to switch between a standby orientation and a heating orientation. When the heating unit is moved to the standby station, the heating unit is located in the containment chamber and in the standby orientation. When the heating unit is moved to the heating station, the heating unit is located on the support platform and in the heating orientation.

A motion mechanism according to the present disclosure includes a first connecting rod, a second connecting rod, a guide pin, and a slot rail. The first connecting rod is connected to a driving mechanism. The second connecting rod is pivotally connected to the first connecting rod to rotate around a pivot axis relative to the first connecting rod. The guide pin is fixed to the second connecting rod. The slot rail is formed with a guide slot which is slidably mated with the guide pin and guides the guide pin to move along the guide slot. When the first connecting rod is driven to move, the second connecting rod drives an operating unit connected to it to switch between different orientations, so that the driven operating unit has different orientations.

According to one embodiment, a motion mechanism is provided. The motion mechanism comprises a first connecting rod 21 connected to a driving mechanism to move with it and a second connecting rod 22 pivotally connected to the first connecting rod 21 to rotate about a pivot axis relative to the first connecting rod 21. The mechanism further includes a guide pin 23 fixed to the second connecting rod 22, and a slot rail 24 formed with a guide slot 240 which is slidably fitted with the guide pin 23 to guide the guide pin 23 to move along the guide slot 240. When the first connecting rod 21 is driven to move, the second connecting rod 22 drives an operating unit connected to it to move between different workstations and switch between different orientations. In this way, the driven operating unit has different orientations at different workstations.

A heating device according to another embodiment of the present disclosure includes a heating unit for heating, and the above-described motion mechanism. The second connecting rod is fixedly connected to the heating unit to drive the heating unit to switch between different orientations, such that the heating unit has different orientations.

A heat shrink machine according to the present disclosure includes a body comprising a containment chamber located at a standby station and a support platform located at a heating station. Cable clamps are installed on the support platform for clamping cables with heat shrink tubes, and the above heating device is installed on the body to heat the heat shrink tubes on the clamped cables. The motion mechanism is used to drive the heating unit to move between the standby station and the heating station and to switch between the standby orientation and the heating orientation. When the heating unit is moved to the standby station, the heating unit is located in the containment chamber and in the standby orientation. When the heating unit is moved to the heating station, the heating unit is located on the support platform and in the heating orientation.

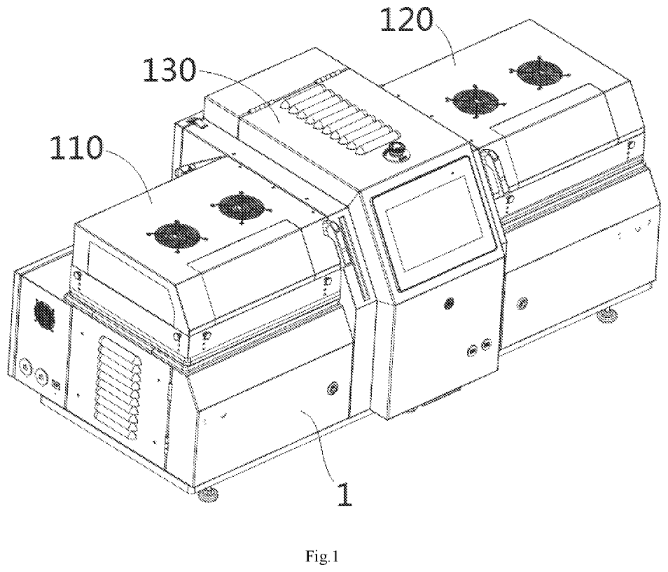

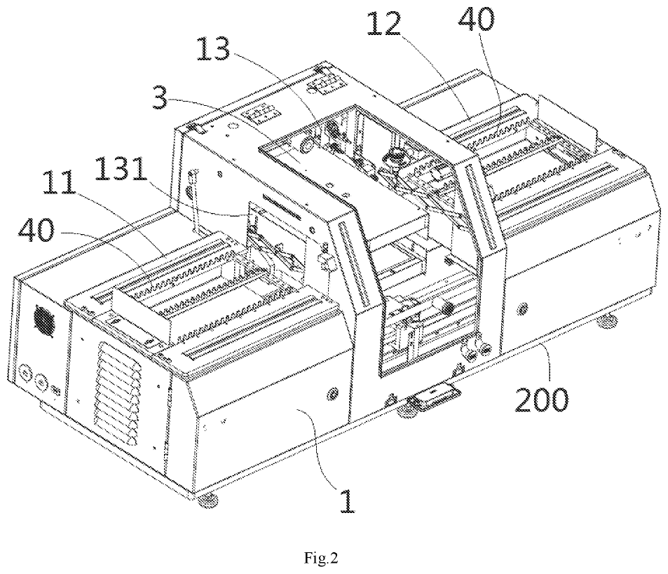

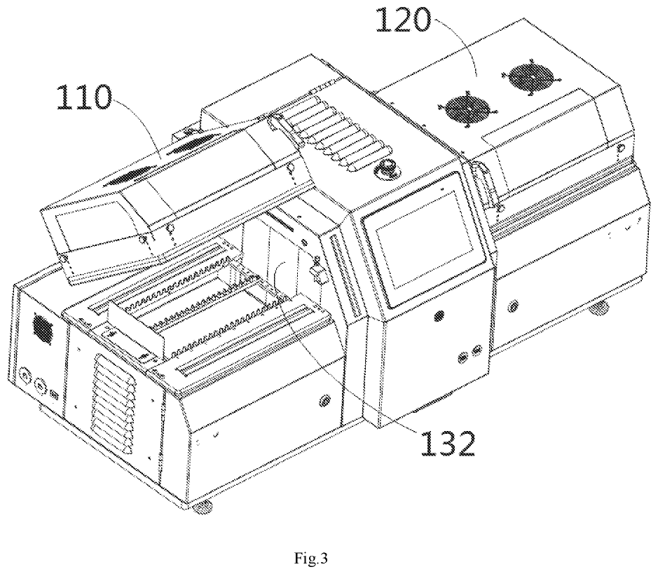

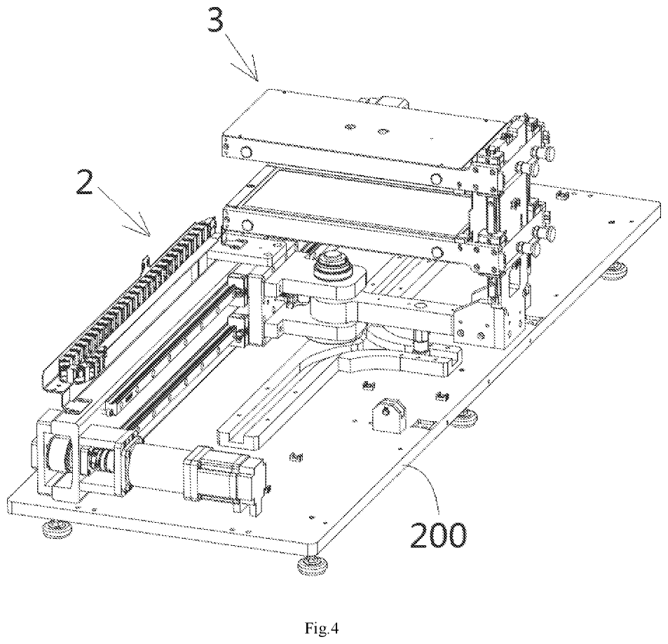

FIG. 1 shows an illustrative perspective view of a heat shrink machine according to an exemplary embodiment of the present invention. FIG. 2 shows an illustrative perspective view of a body 1 of a heat shrink machine according to an exemplary embodiment of the present invention. FIG. 3 shows an illustrative perspective view of a heat shrink machine according to an exemplary embodiment of the present invention, wherein a first upper safety cover 110 on a first support platform 11 is opened, and a second upper safety cover 120 on a second support platform 12 is closed. FIG. 4 shows an illustrative perspective view of the heating device of a heat shrink machine according to an exemplary embodiment of the present invention.

As shown in FIGS. 1 to 4, in the illustrated embodiments, the heat shrink machine mainly comprises the body 1, multiple cable clamps 40, and a heating device. The machine body 1 includes a containment chamber 13 located at the standby station and the support platforms 11, 12 located at the heating station. The multiple cable clamps 40 are installed on the support platforms 11, 12 to clamp multiple cables with heat shrink tubes (not shown). The heating device is installed on the body 1 to heat the heat shrink tubes on the clamped cables, so that the heat shrink tubes are shrined onto the cables. The heating device mainly comprises a motion mechanism 2 and a heating unit 3. Motion mechanism 2 is used to drive the heating unit 3 to move between the standby station and the heating station, and to drive the heating unit 3 to switch between a standby orientation and a heating orientation.

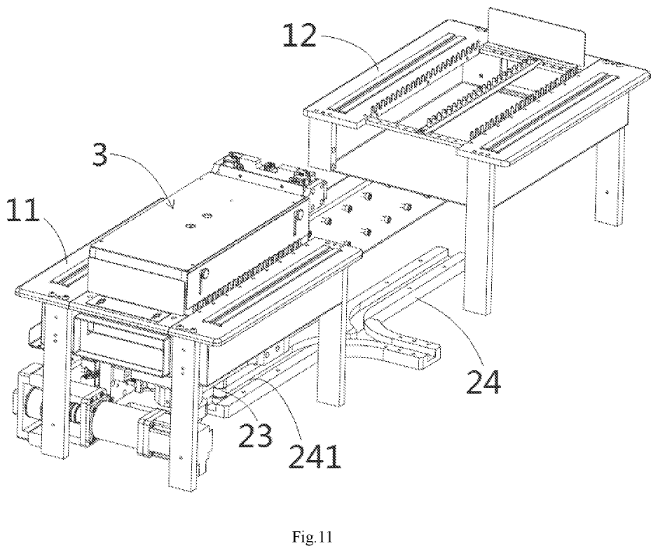

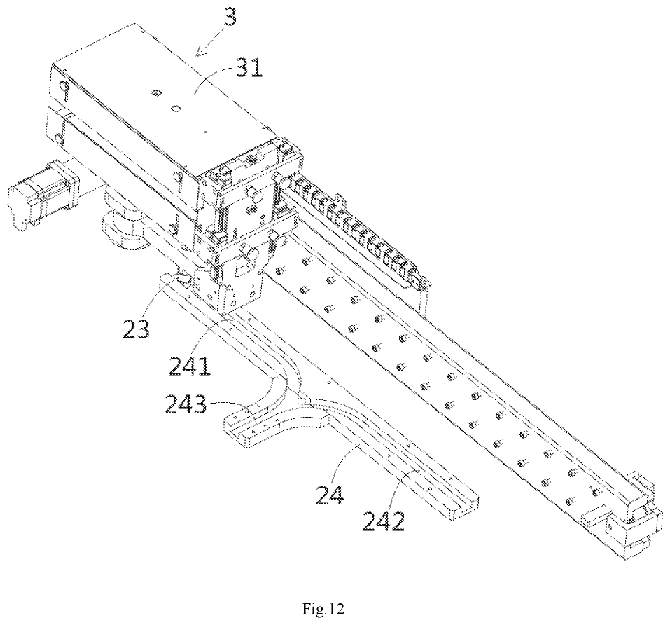

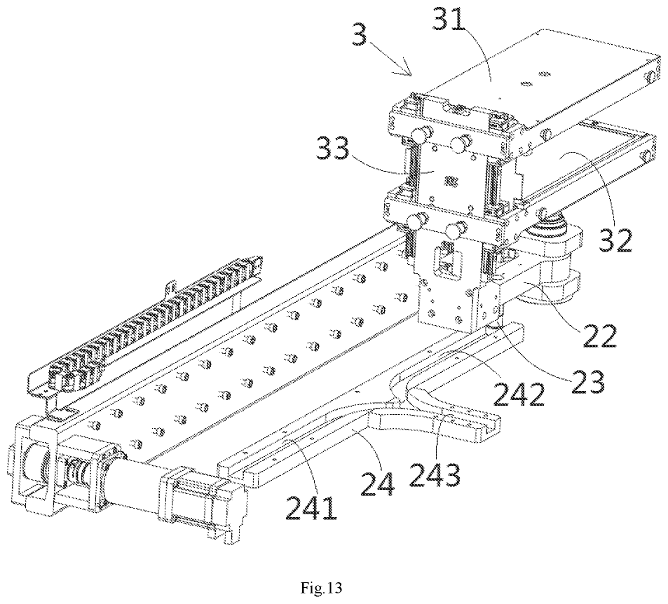

FIG. 11 shows an illustrative view of a heat shrink machine according to an exemplary embodiment of the present invention, wherein the heating unit 3 is located on the first support platform 11. FIG. 12 shows an illustrative view of a heating device of a heat shrink machine according to an exemplary embodiment of the present invention, wherein the heating unit 3 is located at the first heating station and in the first heating orientation. FIG. 13 shows an illustrative view of a heating device of a heat shrink machine according to an exemplary embodiment of the present invention, wherein the heating unit 3 is located at the second heating station and in the second heating orientation.

As shown in FIGS. 1-4 to 11-13, when the heating unit 3 is moved to the standby station, the heating unit 3 is located in the containment chamber 13 and in the standby orientation. When the heating unit 3 is moved to the heating station, it is located on the support platforms 11, 12 and in the heating orientation. In the illustrated embodiments, the support platforms 11, 12 includes the first support platform 11 and the second support platform 12 located at the first heating station and the second heating station, respectively. The first support platform 11 and the second support platform 12 are arranged side by side and are respectively located on the left and right sides of the containment chamber 13.

The motion mechanism 2 is used to drive the heating unit 3 to move between the standby station, the first heating station, and the second heating station, and to drive the heating unit 3 to switch between the standby orientation, the first heating orientation, and the second heating orientation. When the heating unit 3 is moved to the first heating station, the heating unit 3 is located on the first support platform 11 and in the first heating orientation. When the heating unit 3 is moved to the second heating station, the heating unit 3 is located on the second support platform 12 and in the second heating orientation.

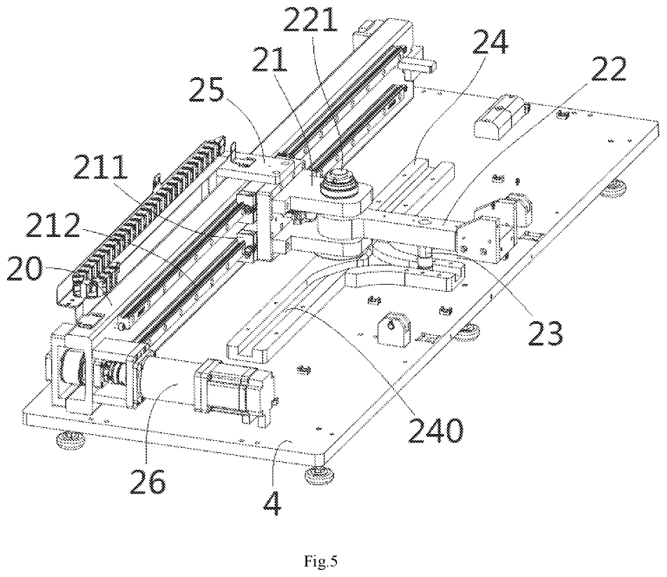

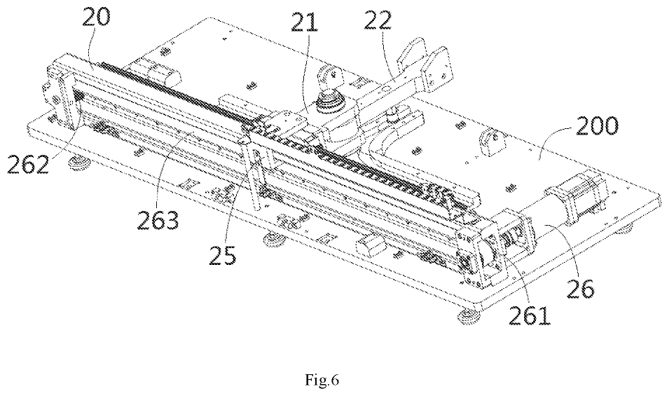

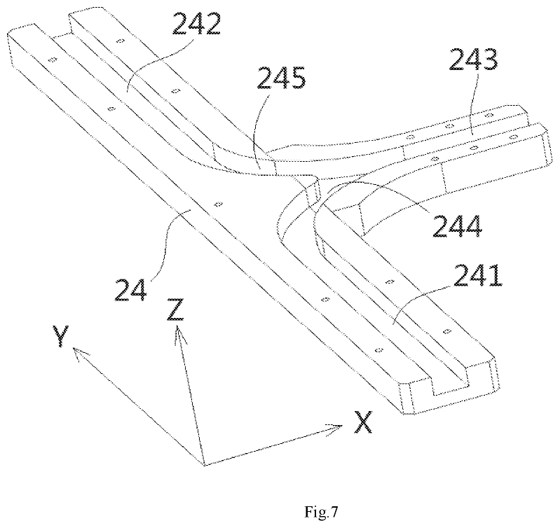

FIG. 5 shows an illustrative perspective view of the motion mechanism 2 of a heat shrink machine according to an exemplary embodiment of the present invention when viewed from one side. FIG. 6 shows an illustrative perspective view of the motion mechanism 2 of a heat shrink machine according to an exemplary embodiment of the present invention when viewed from the other side. FIG. 7 shows an illustrative perspective view of the slot rail 24 of the motion mechanism 2 according to an exemplary embodiment of the present invention.

As shown in FIGS. 1-7 to 11-13, a motion mechanism 2 mainly comprises a first connecting rod 21, a second connecting rod 22, a guide pin 23, and a slot rail 24. The first connecting rod 21 can move in a straight line in the first direction Y. The second connecting rod 22 is rotationally connected to the first connecting rod 21 to be able to rotate relative to the first connecting rod 21 around a pivot axis perpendicular to the first direction Y. In the illustrated embodiment, the second connecting rod 22 is rotatably connected to the first connecting rod 21 through a pivot 221. Guide pin 23 is fixed to the second connecting rod 22. The slot rail 24 is formed with a guide slot 240 that fits with the guide pin 23, used to guide the guide pin 23 to move along the guide slot 240. In the illustrated embodiment, when the first connecting rod 21 is driven to move in a straight line in the first direction Y, the second connecting rod 22 drives the connected operating unit (such as the heating unit 3 in the illustrated embodiment) to move between different workstations and switch between different orientations, so that the driven operating unit has different orientations at different workstations.

The guide slot 240 defines a herringbone shape, by way of example only. The guide slot 240 includes a first slot 241, extending along the first direction Y, a second slot 242 which is in the same straight line as the first slot 241 and is separated from the first slot 241 in the first direction Y. The guide slot 240 further includes third slot 243 which extends along the second direction X perpendicular to the first direction Y and the pivot axis, a first transition slot 244 which is located between one end of the first slot 241 and one end of the third slot 243, and a second transition slot 245 which is located between one end of the second slot 242 and one end of the third slot 243.

When the guide pin 23 moves to the first predetermined position in the first slot 241, the operating unit connected to the second connecting rod 22 is moved to the first operating station (e.g., the first heating station in the illustrated embodiment) and converted to the first operating orientation (e.g., the first heating orientation in the illustrated embodiment). When the guide pin 23 is moved to the second predetermined position in the second slot 242, the operating unit connected to the second connecting rod 22 is moved to the second operating station (e.g., the second heating station in the illustrated embodiment) and converted to the second operating orientation (e.g., the second heating orientation in the illustrated embodiment). When the guide pin 23 moves to the third predetermined position in the third slot 243, the operating unit connected to the second connecting rod 22 is moved to the standby station and converted to the standby orientation.

The first slot 241 and the second slot 242 extend in a first straight line parallel to the first direction Y, and the pivot axis intersects with the first straight line. The operating unit in the standby orientation is converted to the first operating orientation after rotating 90 degrees in one direction around the pivot axis of the second connecting rod 22. The operating unit in the standby orientation is converted to the second operating orientation after rotating 90 degrees in the opposite direction around the pivot axis of the second connecting rod 22.

In the illustrated embodiment, the motion mechanism 2 further comprises a guide rail 212 extending in a straight line in the first direction Y, and a slider 211 installed on the guide rail 212 in a sliding manner. The slider 211 is fixedly connected to the first connecting rod 21, so that the first connecting rod 21 can be driven to move in a straight line in the first direction Y by driving the slider 211.

The motion mechanism 2 further includes a driving device for driving the slider 211 to move in a straight line along the guide rail 212. The driving device comprises a bracket 20, a pair of pulleys 261 and 262 installed on the bracket 20 in a rotating manner, a drive belt 263 connected between the pair of pulleys 261 and 262, a motor 26 fixed to bracket 20 and its output shaft connected to a pulley 261, and a connection piece 25 is fixed to the drive belt 263 and the slider 211. In the illustrated embodiment, the guide rail 212 is fixed to the bracket 20. When the motor 26 rotates, it drives the drive belt 263 to move and drives the slider 211 to move in a straight line along the guide rail 212 through the drive belt 263. The motion mechanism 2 further comprises an installation plate 200. The slot rail 24, guide rail 212, and bracket 20 are fixed to the installation plate 200. In the illustrated embodiment, the installation plate 200 is fixed to the body 1 of the heat shrink machine and forms the bottom seat of the heat shrink machine.

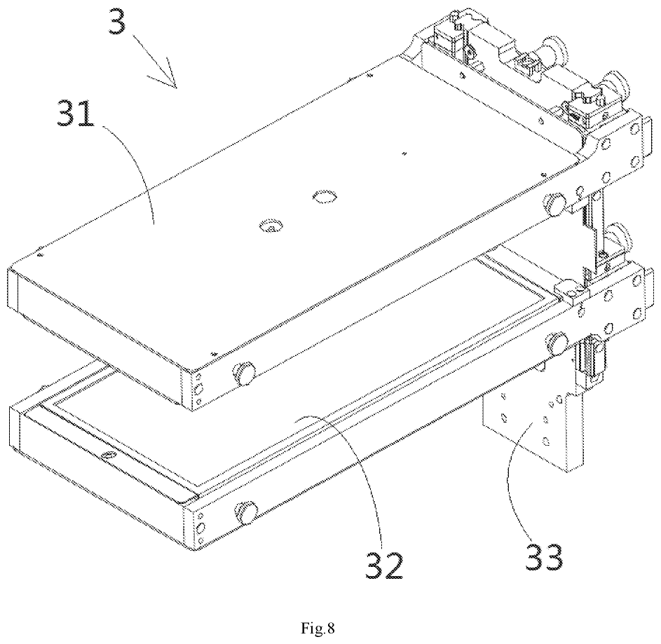

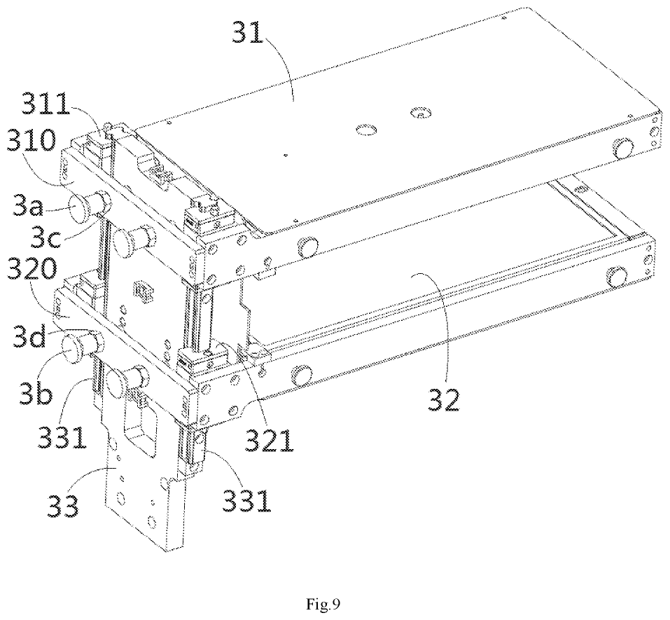

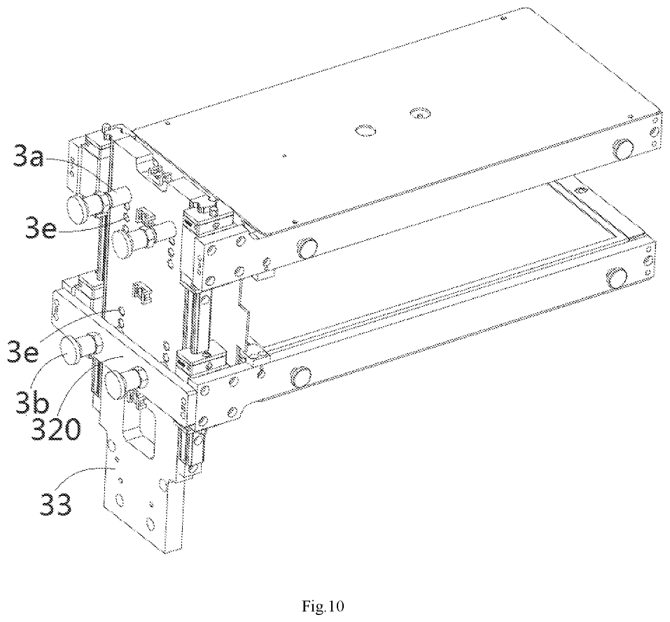

FIG. 8 shows an illustrative perspective view of the heating unit 3 of a heat shrink machine according to an exemplary embodiment of the present invention when viewed from one side. FIG. 9 shows an illustrative perspective view of the heating unit 3 of a heat shrink machine according to an exemplary embodiment of the present invention when viewed from the other side. FIG. 10 shows an illustrative perspective view of the heating unit 3 of a heat shrink machine according to an exemplary embodiment of the present invention, with the first crossbeam 310 removed.

As shown in FIGS. 1 to 13, in an exemplary embodiment of the present invention, a heating device is also disclosed. The heating device mainly includes a heating unit 3 and the aforementioned motion mechanism 2. Heating unit 3 is used to heat the heat shrink tube on the cable. The second connecting rod 22 of the motion mechanism 2 is fixedly connected to the heating unit 3. The second connecting rod 22 is used to drive the heating unit 3 to move between different workstations and switch between different orientations, so that the orientations of the heating unit 3 are different at different workstations.

In the illustrated embodiment, the heating unit 3 comprises a pair of plate shaped heater 31, 32, and a base plate 33. The base plate 33 is fixedly connected to the second connecting rod 22 of the motion mechanism 2 and extends in the third direction Z parallel to the pivot axis of the second connecting rod 22. A pair of plate shaped heater 31, 32 are installed on the base plate 33 and are perpendicular to the third direction Z. At least one of the pair of plate shaped heaters 31, 32 can move along the third direction Z, so that the spacing between the pair of plate shaped heaters 31, 32 can be adjusted to match the diameter of the cable.

The heating unit 3 further comprises a guide rail 331 extending in straight line along a third direction Z. A first slider 311 is slidably installed on the guide rail 331, and a second slider 321 slidably installed on the guide rail 331. One of the pair of plate shaped heaters 31, 32 is fixedly connected to the first slider 311, and the other is fixedly connected to the second slider 321.

Multiple locking holes 3e spaced apart from each other in the third direction Z are formed on the base plate 33. The heating unit 3 also includes a first crossbeam 310, a second crossbeam 320, a first locking pin 3a, and a second locking pin 3b. The first crossbeam 310 is fixedly connected to one end of one plate shaped heater 31 and the first slider 311. A first through-hole 3c is formed in the first crossbeam 310. The second crossbeam 320 is fixedly connected to one end of the other plate-shaped heater 32 and the second slider 321, and a second through-hole 3d is formed in the second crossbeam 320. The first locking pin 3a is inserted into the first through-hole 3c and the corresponding locking hole 3e, to fix one plate shaped heater 31 in the first position. The second locking pin 3b is inserted into the second through-hole 3d and the corresponding locking hole 3e to fix the other plate-shaped heater 32 in the second position.

It should be understood that the present invention is not limited to the illustrated embodiments. For example, in another exemplary embodiment of the present invention, the heating unit 3 may include a first lifting device (not shown) and a second lifting device (not shown). The first lifting device is installed on the base plate 33 and connected to the first slider 311, which is used to drive the first slider 311 to move along the guide rail 331. For example, the first lifting device may include a first motor fixed to the base plate 33, and a first transmission mechanism connected between the output shaft of the first motor and the first slider 311. The second lifting device is installed on the base plate 33 and connected to the second slider 321, for driving the second slider 321 to move along the guide rail 331. For example, the second lifting device may include: a second motor fixed to the base plate 33; and a second transmission mechanism connected between the output shaft of the second motor and the second slider 321.

The present invention is not limited to the illustrated embodiments. For example, in another exemplary embodiment of the present invention, the heating unit 3 may include a driving motor and a threaded rod. The drive motor is installed on the base plate 33 and connected to the threaded rod to drive the threaded rod to rotate. The upper and lower parts of the threaded rod are respectively formed with a first thread and a second thread, and the thread directions of the first thread and the second thread are opposite and connected to the threads of the first slider 311 and the second slider 321, respectively. When the driving motor rotates, the threaded rod drives the pair of plate shaped heater 31, 32 to move towards or away from each other to adjust the spacing between them.

As shown in FIGS. 1 to 13, in the illustrated embodiment, the heating unit 3 in the standby orientation is converted to the first heating orientation after rotating 90 degrees to the left around the pivot axis of the second connecting rod 22. The heating unit 3 in the standby orientation is converted to the second heating orientation after rotating 90 degrees to the right around the pivot axis of the second connecting rod 22.

A row of cable clamps 40 are arranged on the top surface of at least one side of the front, rear, and left sides of the first support platform 11. A row of cable clamps 40 is arranged on the top surface of at least one side of the front, rear, and right sides of the second support platform 12.

When the heating unit 3 is moved to the first support platform 11, the cable can enter a heating region between the pair of plate shaped heater 31, 32 of the heating unit 3 from either side of the front, rear, or left of the first support platform 11. In this way, the application range of heat shrink machines can be expanded. When the heating unit 3 is moved to the second support platform 12, the cable can enter a heating region between the pair of plate shaped heater 31, 32 of the heating unit 3 from either side of the front, rear, and right sides of the second support platform 12. In this way, the application range of heat shrink machines can be expanded.

Openings 131 are formed on the left and right walls of the containment chamber 13, respectively, to allow heating unit 3 to enter and exit the containment chamber 13. Safety doors 132 capable of opening and closing the openings 131 are installed on the left and right walls of accommodating room 13, respectively.

When the heating unit 3 heats the heat shrink tubes on the first support platform 11, the safety door 132 installed on the left wall retracts to open the opening 131 on the left wall, and the safety door 132 installed on the right wall extends to close the opening 131 on the right wall. When the heating unit 3 heats the heat shrink tubes on the second support platform 12, the safety door 132 installed on the right wall retracts to open the opening 131 on the right wall, and the safety door 132 installed on the left wall extends to close the opening 131 on the left wall.

The heat shrink machine further comprises a first upper safety cover 110, a second upper safety cover 120, and a third safety cover 130. The first safety cover 110 is rotatably connected to the left wall of the containment chamber 13 and can be rotated to open and close. The second upper safety cover 120 is rotatably connected to the right wall of the containment chamber 13 and can be rotated to open and close.

When the heating unit 3 heats the heat shrink tubes on the first support platform 11, the first upper safety cover 110 closes to cover the heating unit 3, cable clamps 40, and the heat shrink tubes on the cables located on the first support platform 11, and the second upper safety cover 120 opens to allow the cables to be clamped on the second support platform 12. When the heating unit 3 heats the heat shrink tubes on the second support platform 12, the second upper safety cover 120 closes to cover the heating unit 3, cable clamps 40, and the heat shrink tubes on the cables located on the second support platform 12, and the first upper safety cover 110 opens to allow the cables to be clamped on the first support platform 11. The third safety cover 130 is installed on the top opening of the containment chamber 13 and can be opened and closed.

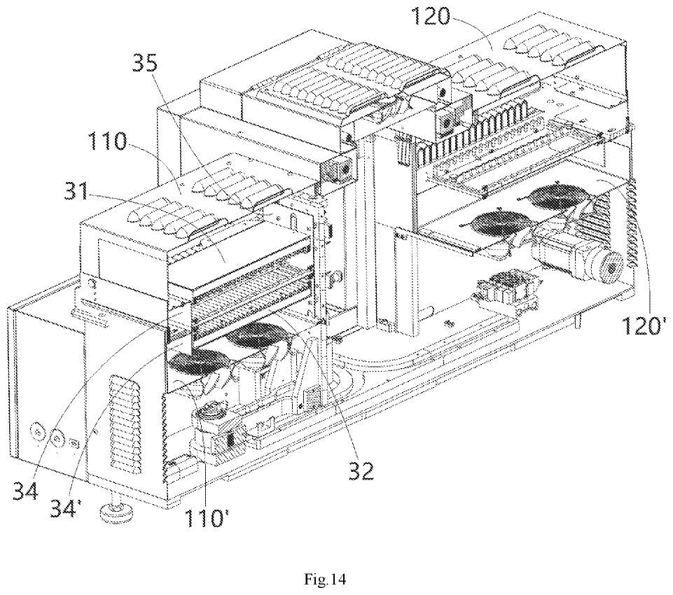

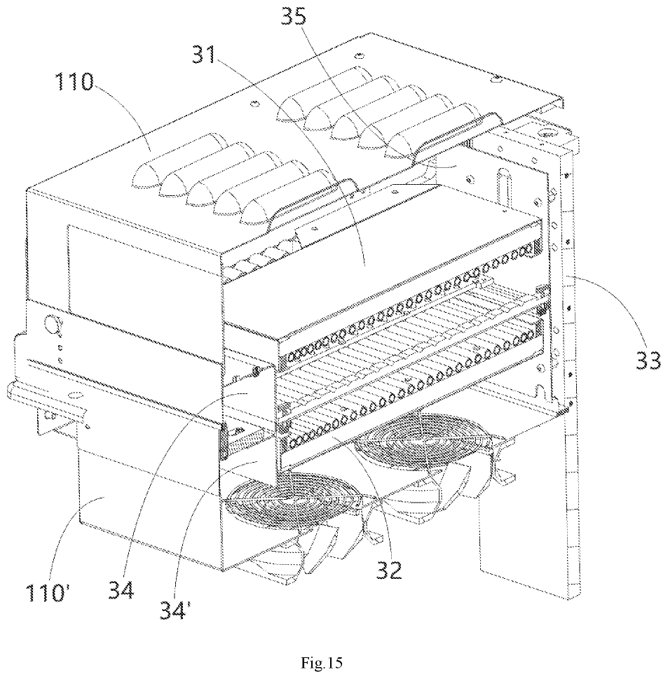

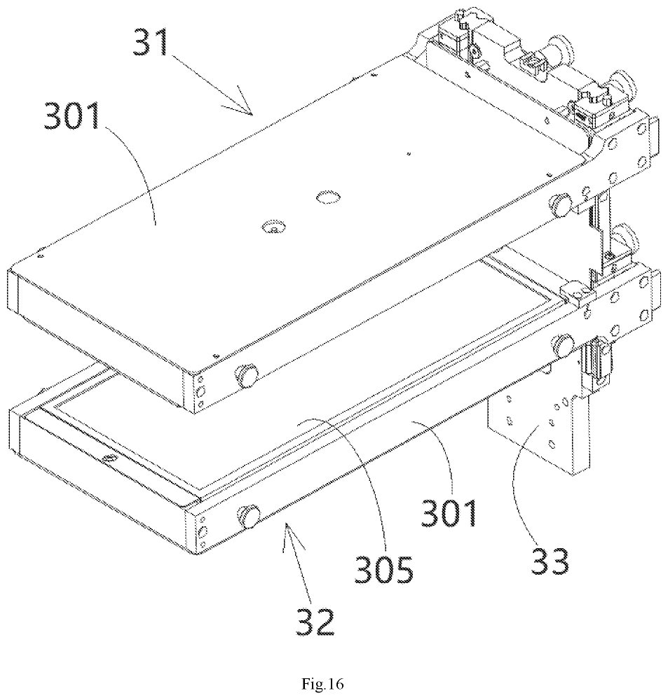

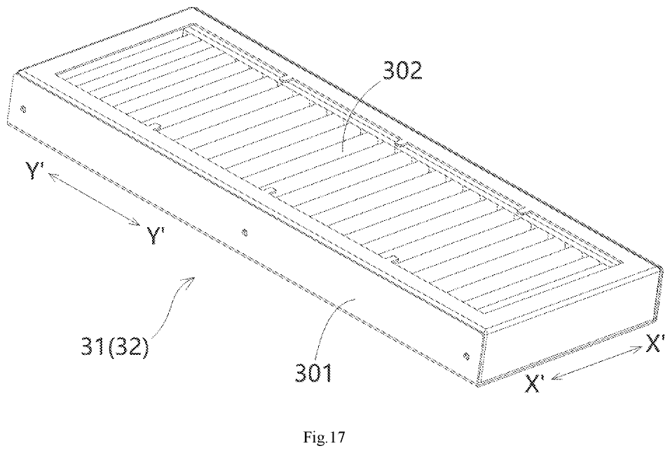

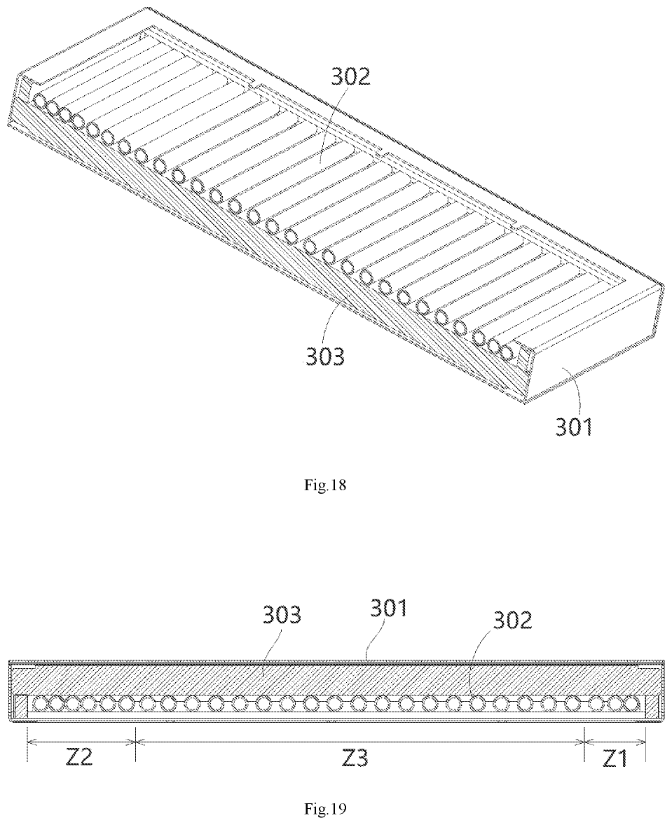

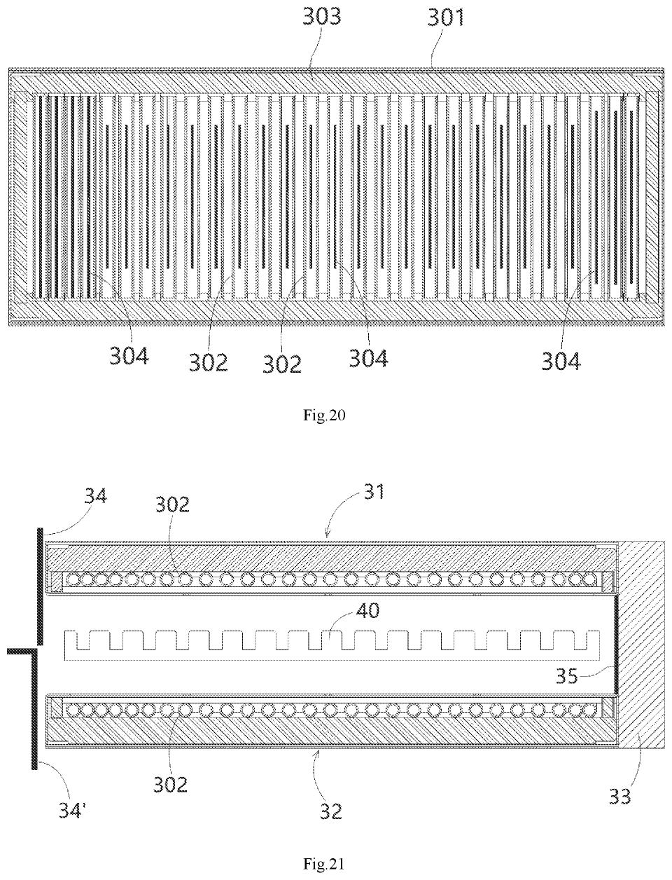

FIG. 14 shows a sectional view of a heat shrink machine according to an exemplary embodiment of the present invention, wherein the heating unit 3 is located at the heating station. FIG. 15 shows a partially enlarged schematic diagram of the heat shrink machine shown in FIG. 14, which shows the heating unit 3, heat reflection plates 34, 34′, 35, and safety covers 110, 120, 110′, 120′. FIG. 16 shows an illustrative perspective view of the heating unit 3 of a heat shrink machine according to an exemplary embodiment of the present invention. FIG. 17 shows an illustrative perspective view of a plate shaped heater 31, 32 according to an exemplary embodiment of the present invention. FIG. 18 shows a longitudinal sectional view of the plate shaped heater 31, 32 according to an exemplary embodiment of the present invention. FIG. 19 shows a vertical sectional view of the plate shaped heater 31, 32 according to an exemplary embodiment of the present invention. FIG. 20 shows a cross-sectional view along the horizontal direction of the plate shaped heater 31, 32 according to an exemplary embodiment of the present invention. FIG. 21 shows a schematic arrangement diagram of heating unit 3 and heat reflection plates 34, 34′, 35 according to an exemplary embodiment of the present invention.

As shown in FIGS. 1 to 21, in an exemplary embodiment of the present invention, the plate shaped heater 31, 32 is disclosed. The plate shaped heater 31, 32 is used to heat the heat shrink tubes on the cables. The plate shaped heater 31, 32 includes a housing 301, multiple heating tubes 302, and a heating wire 304. The housing 301 has opposite ends in its longitudinal direction Y′. Multiple heating tubes 302 are installed in the housing 301. The heating wire 304 is arranged in multiple heating tubes 302. The heating wire 304 can be a single heating wire that passes through multiple heating tubes 302 in sequence, or multiple heating wires that are inserted into multiple heating tubes 302 separately. The heating tube 302 extends along the horizontal direction X′ of the housing 301, and multiple heating tubes 302 are arranged in a row along the longitudinal direction Y′ of the housing 301. The arrangement density of heating tubes 302 in the two end regions Z1 and Z2 near the housing 301 is higher than that in the middle region Z3 between the two end regions Z1 and Z2 of the housing 301. That is to say, the arrangement density of heating tubes 302 in the end region of the plate shaped heater 31, 32 is higher than that in the middle region of the plate shaped heater 31, 32. This makes the heating temperature in the end region of the plate shaped heater 31, 32 basically consistent with the heating temperature in the middle region of the plate shaped heater 31, 32, thereby improving the heating uniformity of the plate shaped heater 31 and 32.

In the illustrated embodiments, the length of the heating wire 304 set in the heating tube 302 in the end regions Z1 and Z2 is greater than the length of the heating wire 304 set in the heating tube 302 in the middle region Z3. This can further improve the heating uniformity of the plate shaped heater 31, 32. The heating region of multiple heating tubes 302 can cover all cable clamps 40, so that the heat shrink tubes of all cables clamped on the cable clamps 40 can be uniformly heated by the plate shaped heater 31, 32. One end of the housing 301 is used to connect to the base plate 33. The aforementioned two end regions Z1 and Z2 include a first end region Z1 near one end of the housing 301 and a second end region Z2 near the other end of the housing 301.

In practical applications, the heat shrink tubes located in the first end region Z1 first enters the heating region between the pair of plate shaped heaters 31, 32, and then the heat shrink tubes located in the second end region Z2 enters the heating region between the pair of plate shaped heaters 31, 32. This results in the heating time of the heat shrink tubes located in the second end region Z2 being shorter than the heating time of the heat shrink tubes located in the first end region Z1. In order to ensure that the heating temperature of the first end region Z1 is substantially the same as that of the second end region Z2, in the illustrated embodiment, the arrangement density of the heating tube 302 in the first end region Z1 is lower than that of the heating tube 302 in the second end region Z2. However, please note that the present invention is not limited to the illustrated embodiments. For example, in another exemplary embodiment of the present invention, the arrangement density of the heating tubes 302 in the first end region Z1 can also be set to be equal to the arrangement density of the heating tubes 302 in the second end region Z2.

In the illustrated embodiments, the length of the heating wire 304 set in the heating tube 302 in the first end region Z1 is smaller than the length of the heating wire 304 set in the heating tube 302 in the second end region Z2. However, the present invention is not limited to the illustrated embodiments. For example, in another exemplary embodiment of the present invention, the length of the heating wire 304 in the heating tube 302 in the first end region Z1 can also be set to be equal to the length of the heating wire 304 in the heating tube 302 in the second end region Z2.

In the illustrated embodiments, the plate shaped heater 31, 32 further includes an adiabatic sponge 303 and a panel 305. The adiabatic sponge 303 is set between the housing 301 and the heating tube 302 to prevent heat from being transferred from the heating tube 302 to the housing 301. The panel 305 is installed on the opening of housing 301, and there is no adiabatic sponge 303 set between the panel 305 and the heating tube 302. The heat generated by the plate shaped heaters 31, 32 radiates outward from the panel 305 to heat the heat shrink tubes on the cables facing the panel 305.

In another exemplary embodiment of the present invention, a heating unit 3 is also disclosed. The heating unit 3 includes a base plate 33 and a pair of plate shaped heaters 31, 32. One ends of the pair of plate shaped heaters 31, 32 are connected to the base plate 33. The pair of plate shaped heaters 31, 32 are spaced opposite and parallel to each other in the height direction perpendicular to their longitudinal direction Y′ and transverse direction X′, used to heat the heat shrink tubes on the cables between the pair of plate shaped heaters 31, 32. At least one of the pair of plate shaped heaters 31, 32 can move in the height direction Z′ relative to the base plate 33, so that the spacing between the pair of plate-shaped heaters 31, 32 can be adjusted to match the diameter of the cable.

In the illustrated embodiment, the heating unit 3 further includes a guide rail 331, a first slider 311, and a second slider 321. The guide rail 331 extends in a straight line along the height direction and is fixed to the base plate 33. The first slider 311 is slidably installed on the guide rail 331. The second slider 321 is slidably installed on the guide rail 331. One of the pair of plate shaped heaters 31, 32 is fixedly connected to the first slider 311, and the other is fixedly connected to the second slider 321, allowing the pair of plate shaped heaters 31, 32 to move along the guide rail 331, respectively.

The heating unit 3 further comprises a first heat reflection plate 35. The first heat reflection plate 35 is provided on the opening at one ends of the pair of plate-shaped heaters 31, 32 and is fixed to the base plate 33. The first heat reflection plate 35 is used to reflect heat into the heating region between the pair of plate shaped heater 31, 32, in order to prevent heat from flowing from the opening at one ends of the pair of plate shaped heaters 31, 32 to the outside of the heating region. This can improve heating efficiency and uniformity.

In another exemplary embodiment of the present invention, a heat shrink machine is also disclosed. The heat shrink machine includes a body 1, cable clamps 40, a heating unit 3, and a motion mechanism 2. The machine body 1 includes a containment chamber 13 located at the standby station and a support platform 11, 12 located at the heating station. Cable clamps 40 are installed on the support platform 11, 12 to clamp cables with heat shrink tubes. The heating unit 3 is used to heat the heat shrink tubes on the cables. The motion mechanism 2 is connected to the base plate 33 of the heating unit 3, which is used to drive the heating unit 3 to move between the standby station and the heating station, and to switch between the standby orientation and the heating orientation. When the heating unit 3 is moved to the standby station, the heating unit 3 is located in the containment chamber 13 and in the standby orientation. When heating unit 3 is moved to the heating station, it is located on support platform 11, 12 and in the heating orientation.

The motion mechanism 2 comprises a first connecting rod 21, a second connecting rod 22, a guide pin 23, and a slot rail 24. The first connecting rod 21 is connected to a driving mechanism and can move accordingly. The second connecting rod 22 is pivotally connected to the first connecting rod 21 to rotate around a pivot axis relative to the first connecting rod 21. The guide pin 23 is fixed to the second connecting rod 22. The slot rail 24 is formed with a guide slot 240 that slidably fits with the guide pin 23, used to guide the guide pin 23 to move along the guide slot 240. The end of the second connecting rod 22 is fixedly connected to the base plate 33 of the heating unit 3.

The pair of plate shaped heaters 31, 32 have a first end connected to the base plate 33 and a second end opposite to the first end. During the movement of heating unit 3 from the standby station to the heating station, the cable clamp 40 enters between the pair of plate shaped heaters 31, 32 through the opening between the second ends of the pair of plate shaped heaters 31, 32.

The heating unit 3 comprises a first heat reflection plate 35. The first heat reflection plate 35 is provided on the opening at the first ends of the pair of plate shaped heaters 31, 32. The first heat reflection plate 35 is used to reflect heat into the heating region between the pair of plate shaped heaters 31, 32, in order to prevent heat from flowing from the opening at the first ends of the pair of plate shaped heaters 31, 32 to the outside of the heating region. This can improve heating efficiency and uniformity.

The heat shrink machine further comprises second heat reflection plates 34, 34′. The second heat reflection plates 34, 34′are fixed to the support platform 11, 12 or the housing 301 of the plate shaped heater 31, 32. When the heating unit 3 is moved to the heating station, the second heat reflection plates 34, 34′ cover the opening of the second ends of the pair of plate shaped heater 31, 32, which is used to reflect heat into the heating region between the pair of plate shaped heater 31, 32, to prevent heat from flowing from the opening at the second ends of the pair of plate shaped heater 31, 32 to the outside of the heating region. This can improve heating efficiency and uniformity. The second heat reflection plates 34, 34′ include an upper reflection plate 34 and a lower reflection plate 34′. The upper reflection plate 34 is located above and fixed to the support platform 11, 12. The lower reflection plate 34′ is located below and fixed to the support platform 11, 12.

The heat shrink machine further comprises safety covers 110, 120, 110′, and 120′. The safety covers 110, 120, 110′, and 120′ are installed on the body 1. When heating the heat shrink tubes on the cables, the heating unit 3 is accommodated in the safety covers 110, 120, 110′, 120′ to isolate it from external air. The safety covers 110, 120, 110′, 120′ include: upper safety covers 110, 120, and lower safety covers 110′, 120′. The upper safety covers 110, 120 are located above the support platform 11, 12 and can be opened and closed. The lower safety covers 110′, 120′ are located below and fixed to the support platform 11, 12.

By increasing the driving speed of the motion mechanism 2, the time for heating unit 3 to move from the standby station to the heating station or from the heating station to the standby station does not exceed 1 second. This can reduce the heating time difference between the two ends of the plate shaped heater 31, 32, thereby further improving heating uniformity.

Please note that the structure of the heat shrink machine of the present invention is not limited to the illustrated embodiments. For example, in the present invention, the pair of plate shaped heaters 31, 32 in the heating unit 3 can also move from one side to the other along the lateral direction (in the second direction X in the figure) of the support platform 11, 12.

In addition, those areas in which it is believed that those of ordinary skill in the art are familiar, have not been described herein in order not to unnecessarily obscure the invention described. Accordingly, it has to be understood that the invention is not to be limited by the specific illustrative embodiments, but only by the scope of the appended claims.

It should be appreciated for those skilled in this art that the above embodiments are intended to be illustrated, and not restrictive. For example, many modifications may be made to the above embodiments by those skilled in this art, and various features described in different embodiments may be freely combined with each other without conflicting in configuration or principle.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

As used herein, an element recited in the singular and proceeded with the word “a” or “an” should be understood as not excluding plural of the elements or steps, unless such exclusion is explicitly stated. Furthermore, references to “one embodiment” of the present disclosure are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

What is claimed is:

1. A plate shaped heater for heating a heat shrink tube on a cable, comprising:
a housing having opposite ends in its longitudinal direction;
multiple heating tubes arranged in the housing, the heating tubes extending along a transverse direction of the housing and arranged in a row along the longitudinal direction of the housing, an arrangement density of the heating tubes in two end regions proximate two ends of the housing is greater than an arrangement density of the heating tubes in a middle region between the two end regions of the housing; and
a heating wire arranged in the multiple heating tubes.

2. The plate shaped heater according to claim 1, wherein a length of the heating wire arranged in the heating tube in each of the end regions is greater than a length of the heating wire arranged in the heating tube in the middle region.

3. The plate shaped heater according to claim 1, wherein the heating region of the multiple heating tubes covers a plurality of cable clamps.

4. The plate shaped heater according to claim 1, wherein:
one end of the housing is adapted to connect to a base plate;
the two end regions include a first end region proximate one end of the housing and a second end region proximate a second end of the housing; and
the arrangement density of the heating tubes in the first end region is less than or equal to the arrangement density of the heating tubes in the second end region.

5. The plate shaped heater according to claim 4, wherein a length of the heating wire arranged in the heating tube in the first end region is less than or equal to a length of the heating wire arranged in the heating tube in the second end region.

6. The plate shaped heater according to claim 1, further comprising:
an adiabatic sponge arranged between the housing and at least one of the heating tubes and adapted to prevent heat from being transferred from the at least one heating tube to the housing; and
a panel installed on an opening of the housing, wherein no adiabatic sponge is arranged between the panel and the at least one heating tube, and the heat generated by the plate shaped heater radiates outward from the panel to heat the heat shrink tube on the cable.

7. A heating unit, comprising:
a base plate; and
a pair of plate shaped heaters each having an end connected to the base plate, each plate shaped heater including:
a housing having opposite ends in its longitudinal direction;
multiple heating tubes arranged in the housing, the heating tubes extending along a transverse direction of the housing and arranged in a row along the longitudinal direction of the housing, an arrangement density of the heating tubes in two end regions proximate two ends of the housing is greater than an arrangement density of the heating tubes in a middle region between the two end regions of the housing; and
a heating wire arranged in the multiple heating tubes, the pair of plate shaped heaters are spaced opposite and parallel to each other in a height direction perpendicular to the longitudinal direction and the transverse direction of the plate shaped heater.

8. The heating unit according to claim 7, wherein at least one of the pair of plate shaped heaters is movable relative to the base plate along the height direction, such that the spacing between the pair of plate shaped heaters is capable of being adjusted to match the diameter of the cable.

9. The heating unit according to claim 8, further comprising:
a guide rail extending in a straight line along the height direction and fixed to the base plate;
a first slider slidably installed on the guide rail; and
a second slider slidably installed on the guide rail, one of the pair of plate shaped heaters fixedly connected to the first slider, and the other fixedly connected to the second slider such that the pair of plate shaped heaters are movable along the guide rail.

10. The heating unit according to claim 7, further comprising a first heat reflection plate arranged at an opening at ends of the pair of plate shaped heaters and fixed to the base plate, the first heat reflection plate is adapted to reflect heat into the heating region between the pair of plate shaped heaters to prevent heat from flowing from the opening at one ends of the pair of plate shaped heaters to the outside of the heating region.

11. A heat shrink machine, comprising:
a body including a containment chamber located at a standby station and a support platform located at a heating station;
cable clamps installed on the support platform for clamping cables with heat shrink tubes;
a heating unit, comprising:
a base plate; and
a pair of plate shaped heaters each having an end connected to the base plate, each plate shaped heater including:
a housing having opposite ends in its longitudinal direction;
multiple heating tubes arranged in the housing, the heating tubes extending along a transverse direction of the housing and arranged in a row along the longitudinal direction of the housing, an arrangement density of the heating tubes in two end regions proximate two ends of the housing is greater than an arrangement density of the heating tubes in a middle region between the two end regions of the housing; and
a heating wire arranged in the multiple heating tubes, the pair of plate shaped heaters are spaced opposite and parallel to each other in a height direction perpendicular to the longitudinal direction and the transverse direction of the plate shaped heater, for heating the heat shrink tubes on cables located between the pair of plate shaped heater; and
a motion mechanism connected to the base plate of the heating unit, the motion mechanism adapted to drive the heating unit to move between the standby station and the heating station, and to switch between a standby orientation and a heating orientation, when the heating unit is moved to the standby station, the heating unit is located in the containment chamber and in the standby orientation, and when the heating unit is moved to the heating station, the heating unit is located on the support platform and in the heating orientation.

12. The heat shrink machine according to claim 11, wherein the motion mechanism comprises:
a first connecting rod is connected to a driving mechanism to move with the driving mechanism;
a second connecting rod pivotally connected to the first connecting rod to rotate about a pivot axis relative to the first connecting rod;
a guide pin fixed to the second connecting rod; and
a slot rail formed with a guide slot that slidably engages with the guide pin, the slot rail guiding the guide pin to move along the guide slot, an end of the second connecting rod fixedly connected to the base plate of the heating unit.

13. The heat shrink machine according to claim 11, wherein:
the plate shaped heater has a first end connected to the base plate and a second end opposite to the first end; and
during the movement of the heating unit from the standby station to the heating station, the cable clamp enters into a heating region between the pair of plate shaped heaters through an opening at the second ends of the pair of plate shaped heaters.

14. The heat shrink machine according to claim 13, wherein the heating unit comprises a first heat reflection plate arranged on an opening at the first ends of the pair of plate shaped heaters and adapted to reflect heat into the heating region between the pair of plate shaped heaters, the first heat reflection plate preventing heat from flowing from the opening at the first ends of the pair of plate shaped heaters to the outside of the heating region.

15. The heat shrink machine according to claim 13, further comprising a second heat reflection plate fixed to the support platform or the housing of the plate-shaped heater, when the heating unit is moved to the heating station, the second heat reflection plate covers the opening at the second ends of the pair of plate shaped heaters and reflects heat into the heating region between the pair of plate shaped heaters.

16. The heat shrink machine according to claim 15, wherein the second heat reflection plate comprises:
an upper reflection plate arranged above the support platform and fixed to the support platform; and
a lower reflection plate arranged below the support platform and fixed to the support platform.

17. The heat shrink machine according to claim 15, further comprising a safety cover installed on the body, when heating the heat shrink tubes on the cables, the heating unit is accommodated in the safety cover to isolate the heating unit from external air.

18. The heat shrink machine according to claim 17, wherein the safety cover includes an upper safety cover arranged above the support platform and adapted to be opened and closed.

19. The heat shrink machine according to claim 18, wherein the safety cover further includes a lower safety cover arranged below the support platform and fixed to the support platform.

20. The heat shrink machine according to claim 19, wherein a time for the heating unit to move from the standby station to the heating station or from the heating station to the standby station is less than or equal to 1 second.
